(19) United States
(12) Patent Application Publication
(10) Pub. No.: US 2023/0289517 A1
(43) Pub. Date: Sep. 14, 2023

(54) DISPLAY APPARATUS, DISPLAY METHOD, AND NON-TRANSITORY RECORDING MEDIUM

(71) Applicant: Takuroh Yoshida, Kanagawa (JP)

(72) Inventor: Takuroh Yoshida, Kanagawa (JP)

(73) Assignee: Ricoh Company, Ltd., Tokyo (JP)

(21) Appl. No.: 18/171,940

(22) Filed: Feb. 21, 2023

(30) Foreign Application Priority Data
Mar. 10, 2022 (JP) 2022-037463
Nov. 30, 2022 (JP) 2022-192226

(51) Int. Cl. G06F 40/177; G06F 3/04883; G06T 11/00; G06T 3/40

(52) U.S. Cl. CPC G06F 40/177; G06F 3/04883; G06T 11/001; G06T 3/40

(57) ABSTRACT

A display apparatus includes circuitry to display a table on a screen; receive an input of hand drafted data, determine whether the hand drafted data overlaps the table, and convert the hand drafted data into a text or a shape. Based on a determination that the hand drafted data overlaps the table, the circuitry acquires an attribute set to the table from a memory, and displays the text or the shape in the table in accordance with the attribute.

### CROSS-REFERENCE TO RELATED APPLICATIONS

This patent application is based on and claims priority pursuant to 35 U.S.C. § 119(a) to Japanese Patent Application Nos. 2022-037463, filed on Mar. 10, 2022, and 2022-192226, filed on Nov. 30, 2022, in the Japan Patent Office, the entire disclosure of which is hereby incorporated by reference herein.

### BACKGROUND

### Technical Field

Embodiments of the present disclosure relate to a display apparatus, a display method, and a non-transitory recording medium.

### Related Art

There are display apparatuses that convert handwritten data to a character string (character codes) and display the character string on a screen by using a handwriting recognition technology. A display apparatus having a relatively large touch panel is used in a conference room or the like and is shared by a plurality of users as an electronic whiteboard or the like.

There is a technology for converting a handwritten table into a digital table object. There is also a technology for converting a handwritten table into a digital table object and converting handwritten numerals into text data.

### SUMMARY

In one aspect, a display apparatus includes circuitry to display a table on a screen; receive an input of hand drafted data, determine whether the hand drafted data overlaps the table, and convert the hand drafted data into a text or a shape. Based on a determination that the hand drafted data overlaps the table, the circuitry acquires an attribute set to the table from a memory, and displays the text or the shape in the table in accordance with the attribute.

In another aspect, a display method includes displaying a table on a screen; receiving an input of hand drafted data, converting the hand drafted data into a text or a shape, determining whether the hand drafted data overlaps the table, and acquiring an attribute set to the table from a memory based on a determination that the hand drafted data overlaps the table, and displaying the text or the shape in the table in accordance with the attribute.

In another aspect, a non-transitory recording medium stores a plurality of program codes which, when executed by one or more processors, causes the processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A to 1D are diagrams illustrating a process of table inputting of a set of hand drafted strokes performed by a display apparatus according to embodiments;

FIG. 2A to FIG. 2C are diagrams each illustrating an example of a placement of the display apparatus in use, according to embodiments of the disclosure;

FIG. 3 is a block diagram illustrating an example of a hardware configuration of the display apparatus according to embodiments;

FIG. 4 is a block diagram illustrating an example of a functional configuration of the display apparatus according to embodiments;

FIG. 5 is a diagram illustrating information on object data stored in an object data storage area according to embodiments;

FIG. 6 is a diagram illustrating table information stored in a table information storage area according to embodiments;

FIG. 7 is a diagram illustrating an example of a neighborhood rectangle;

FIGS. 8A to 8C are diagram illustrating an example of determination of a target subjected to table inputting based on conditions 1 and 2;

FIGS. 9A and 9B are diagrams illustrating an example of determination of a target subjected to shape inputting based on the conditions 1 and 2;

FIG. 10 is a flowchart illustrating a process of table inputting of a table-input text candidate when a stroke set of the same recognition group satisfy the conditions 1 and 2, according to an embodiment;

FIG. 11 is a diagram illustrating a same recognition group in a case where a predetermined time T has not elapsed from the pen-up, according to embodiments;

FIG. 12 is a diagram illustrating a same recognition group in a case where the time T has elapsed from the pen-up, according to embodiments;

FIG. 13 is a diagram illustrating conditions under which stroke data is determined not to belong to the recognition group of previous stroke data, according to embodiments;

FIG. 14 is a flowchart illustrating a process in which a recognition group determination unit determines stroke data of the same recognition group according to embodiments;

FIG. 15 is a flowchart illustrating an example of a process for determining whether the stroke data satisfies an excluding condition for exclusion from the same recognition group, described in steps S21, S23, and S27 in FIG. 14;

FIGS. 16A and 16B illustrate a conversion example of a stroke handwritten in a cell in which hiding of an operation guide is set;

FIGS. 17A and 17B are diagrams illustrating an example of automatic calculation of a sum in a table and copying of a value of a cell to another table;

FIGS. 18A and 18B illustrate an example of table information of the tables illustrated in FIGS. 17A and 17B; and

FIG. 19 is a schematic diagram illustrating a configuration of a display system according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a display apparatus and a display method performed by the display apparatus according to embodiments of the present disclosure, with reference to the attached drawings.

Outline of Table Inputting

The display apparatus according to the present embodiment improves user convenience regarding setting of attributes (such as font size and color) of text and shapes converted from handwriting, in accordance with the table and the shape. The display apparatus according to the present embodiment performs formatting of text (character string), symbols, and shapes input by a user into a table or a shape, without a user's switching operation from a handwriting recognition mode to a table inputting mode.

In a conventional technology, for using handwriting recognition of handwriting input to a table or a figure, attributes (such as a font size or a color) of a text or a shape converted from the handwriting are set in advance in accordance with the table or the figure. The present embodiment can obviate such preliminarily setting.

The display apparatus according to the present embodiment performs character recognition without a user's switching operation from the table inputting mode to the handwriting recognition mode. That is, the display apparatus simply performs character recognition of strokes hand-drawn on the table by the user in some cases, and further performs table inputting of a character-recognized text in association with the table in some cases. Inputting text in association with a table is hereinafter referred to as “inputting to table,” “table inputting,” or “table input.” The text input to the table is displayed or processed with an attribute set in the table. The processing to change the appearance of text (a character string) in accordance with the attributes set in the table is referred to as “formatting.”

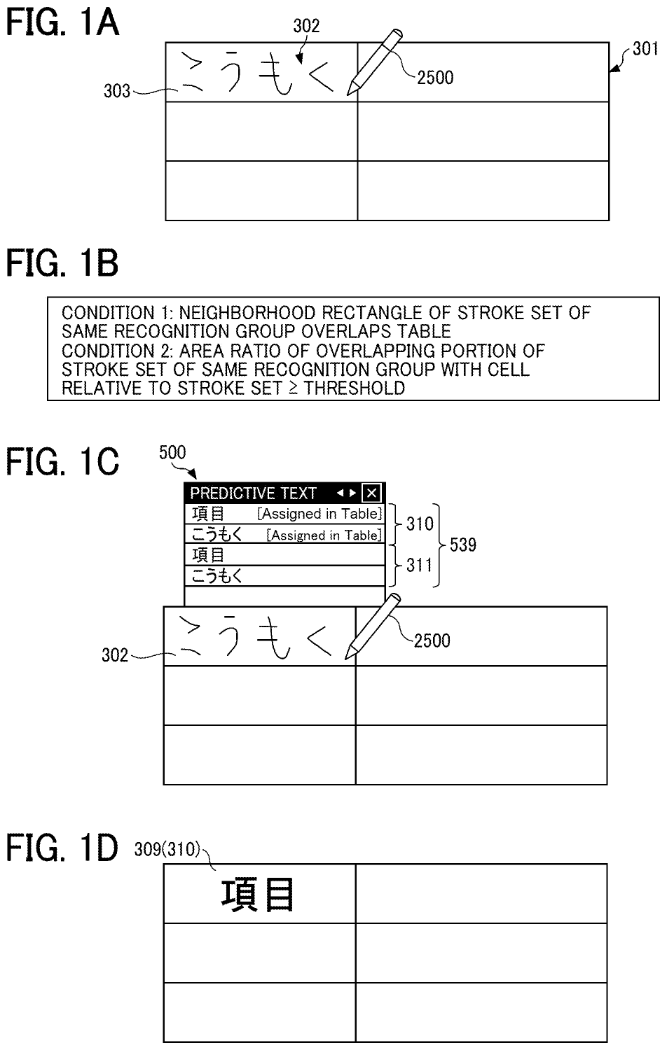

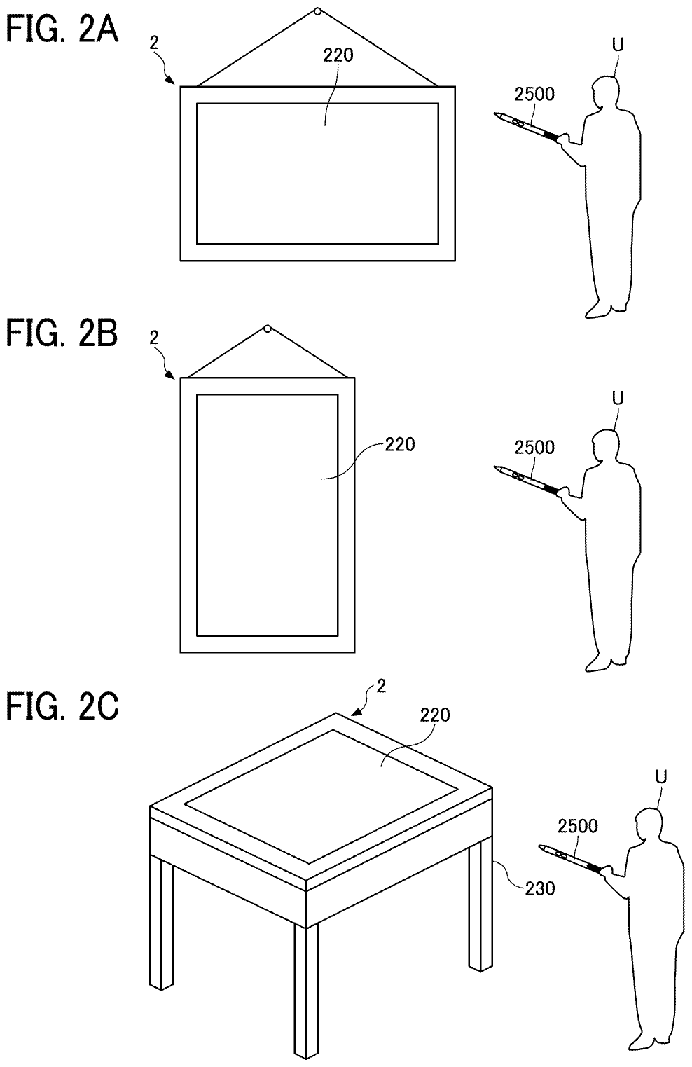

FIGS. 1A to 1D are diagrams illustrating a process of table inputting of a set of hand drafted strokes. As illustrated in FIG. 1A, when a user handwrites one or more strokes (hereinafter referred to as a stroke set 302 of the same recognition group) in a cell 303 of a table 301, for example, with a pen 2500, a display apparatus 2 (see FIGS. 2A to 2C) determines whether or not the stroke set 302 satisfy conditions 1 and 2 (FIG. 1B). In FIG. 1A, the stroke set 302 represents a Japanese Hiragana character string “ [symbol] ” pronounced as “koumoku” and meaning “item.” Condition 1: the neighborhood rectangle of a stroke set of same recognition group overlaps a table, Condition 2: the area ratio between stroke set of the same recognition group and the cell is equal to or greater than a threshold. The conditions 1 and 2 are for determining whether or not the stroke set 302 of the same recognition group overlaps the cell 303. The conditions 1 and 2 will be described in detail later. The term “same recognition group” refers to one or more strokes that are collectively converted into a text or a shape, for example. The detailed description of this operation is described below.

When the stroke set 302 of the same recognition group satisfies the conditions 1 and 2, as illustrated in FIG. 1C, the display apparatus 2 determines that there is a possibility that the stroke set 302 of the same recognition group is subjected to table inputting. Then, the display apparatus 2 displays an operation guide 500 in which conversion candidates 539 (candidates of text to which the hand-drafted stroke set is converted) include one or more table-input text candidate 310 (an example of first conversion candidate and an example of first text). The table-input text candidate 310 is a candidate of a text that is input as a value of the cell 303 and with formatting in accordance with an attribute set to the table. In FIG. 1C, the conversion candidates 539 such as “ [symbol] (Assigned in Table),” “ [symbol] (Assigned in Table),” and “ [symbol] ” are displayed for the stroke set “ [symbol] ” The Chinese character string “ [symbol] ” is an idiom meaning “item.” The “ [symbol] (Assigned in Table)” and “ [symbol] (Assigned in Table)” are the table-input text candidates 310. The table-input text candidates 310 are associated with the table and displayed with the attribute set in the cell 303 of the table 301. The conversion candidates 539 further includes text candidates 311 (an example of second first conversion candidate and an example of second text) that are not the table-input text candidates 310. The text candidates 311 are displayed at positions where the stroke set is handwritten in accordance with the attribute initially set in the display apparatus 2 irrespective of the table.

When the user handwrites a shape, the display apparatus 2 displays, as the conversion candidates 539, a shape (another example of first conversion candidate and an example of first shape) to be input to the table 301 and another shape (another example of second first conversion candidate and an example of second shape) to be displayed at a position where the stroke set is handwritten in accordance with the attribute initially set in the display apparatus 2, irrespective of the table 301.

When the user selects the table-input text candidate 310 “ [symbol] (Assigned in Table),” as illustrated in FIG. 1D, the display apparatus 2 displays the selected table-input text candidate 310 as a cell value 309 “ [symbol] ” in accordance with the attribute set to the cell 303 in which the stroke set 302 is handwritten. For example, even if the user does not designate attributes such as a font, a color, or a position in a cell, the display apparatus 2 can display the cell value 309 with predetermined attributes (initial attributes). Further, as the user moves the table 301, the cell value 309 “ [symbol] ” is also moved and kept in the cell 303 of the table 301.

The user can also select one of the text candidates 311 that is not the table-input text candidate 310 from the conversion candidates 539. In this case, the display apparatus 2 allows the user to freely input a note that is not to be table-input as a value of a cell.

When the display apparatus 2 performs processing of, for example, extracting only the table-input text candidates 310 and writing the extracted table-input text candidates 310 in a file, the display apparatus 2 can automatically separate the table-input text candidates 310 from the other texts.

As described above, the display apparatus 2 according to the present embodiment obviates the user operation of switching the mode, for performing character recognition without table inputting and performing table inputting of a character-recognized text. Table-input texts can be displayed and processed according to table attributes, and texts that are not targets of table inputting are not affected by the table attributes. In addition, the display apparatus 2 of the present embodiment determines whether or not a stroke set of the same recognition group overlaps a cell and displays the table-input text candidate 310 selectably by the user. Accordingly, a cell and a text can be accurately associated. Note that the content handwritten by the user is not limited to text. In addition to converting hand drafted data into text, hand drafted may be converted into a shape, a stamp, or the like. When the converted shape satisfies the conditions 1 and 2, the display apparatus 2 may display a table-input shape candidate as the conversion candidate 539 and receive the selection from the user.

### Terminology

“Input device” may be any means with which a user inputs handwriting (hand drafting) by designating coordinates on a touch panel. Examples thereof include a pen, a human finger, a human hand, and a bar-shaped member.

A series of user operations including engaging a writing mode, recording movement of an input device or portion of a user, and then disengaging the writing mode is referred to as a stroke. For example, a stroke is a series of user operations of pressing an input device against a display or screen, continuously or successively moving the input device on the display, and releasing the input device from the display. Alternatively, a stroke includes movement of the portion of the user without contacting a display or screen, and the display apparatus can track the movement. In this case, the display apparatus may start tracking and recording (recognize engaging or turning on the writing mode) in response to a gesture of the user, pressing a button with a hand or a foot of the user, or other operation of, for example, using a mouse or pointing device. Further, the display apparatus may end tracking and recording (recognize disengaging or turning off the writing mode) in response to the same or different gesture, releasing the button, or other operation, for example using the mouse or pointing device.

“Stroke data” is data displayed on a display based on a trajectory of coordinates of a stroke input with the input device. The stroke data may be interpolated appropriately. In the description of embodiments, “hand drafted input data” refers to data having one or more pieces of stroke data. “Hand drafted input” relates to a user input such as handwriting, drawing, and other forms of input. The hand drafted input may be performed via touch interface, with a tactile object such as a pen or stylus or with the user's body. The hand drafted input may also be performed via other types of input, such as gesture-based input, hand motion tracking input or other touch-free input by a user. The embodiments of the present disclosure relate to handwriting and handwritten data, but other forms of hand drafted input may be utilized and are within the scope of the present disclosure.

An “object” refers to an item displayed on a screen and includes an object drawn by stroke data.

The term “object” in this specification also represents an object of display.

An “object” obtained by handwriting recognition and conversion of stroke data may include, in addition to character strings, a stamp of a given character or mark such as “complete,” a shape such as a circle or a star, or a line.

A “table” refers to a style of presentation in which pieces of information are arranged so as to be easily viewed. The table includes a one dimensional table and a two dimensional table, and either table may be used in this embodiment. Also, there may be only one cell in the table.

An “input area” refers to an area surrounded by a frame such as a cell of a table or a shape. The input area may be a simple input field, for example, on a web page. In the present embodiment, attributes are set in the input area in advance.

The “attributes” set in the input area is a format of text preferable for the input area.

The attributes are, for example, font, color of text, arrangement of text in the input area, etc.

Examples of the “shape” include various shapes, outlines, contours, or line shapes, determined by a certain rule. Although there are many types of shapes such as triangle, quadrangle, circle, and rhombus, a shape for creating an electronic signature is set in advance.

The user can display the shape as an object input to the display or use the shape to select table inputting. Accordingly, in the present embodiment, whether or not a stroke is recognized as a text or shape is determined.

Configuration of Apparatus

Referring to FIGS. 2A to 2C, a description is given of a general arrangement of the display apparatus 2 according to the present embodiment. FIG. 2A to FIG. 2C are diagrams each illustrating an example of a placement of the display apparatus 2 in use according to the present embodiment. FIG. 2A illustrates, as an example of the display apparatus 2, an electronic whiteboard having a landscape-oriented rectangular shape and being hung on a wall.

As illustrated in FIG. 2A, the display apparatus 2 includes a display 220 (a screen). A user U handwrites (inputs or draws), for example, a character on the display 220 using a pen 2500.

FIG. 2B illustrates, as another example of the display apparatus 2, an electronic whiteboard having a portrait-oriented rectangular shape and being hung on a wall.

FIG. 2C illustrates, as another example, the display apparatus 2 placed on the top of a desk 230. The display apparatus 2 has a thickness of about 1 centimeter. It is not necessary to adjust the height of the desk 230, which is a general-purpose desk, when the display apparatus 2 is placed on the top of the desk 230. Further, the display apparatus 2 is portable and easily moved by the user.

Examples of an input method of coordinates by the pen 2500 include an electromagnetic induction method and an active electrostatic coupling method. In other example, the pen 2500 further has functions such as drawing pressure detection, inclination detection, a hover function (displaying a cursor before the pen is brought into contact), or the like.

Hardware Configuration

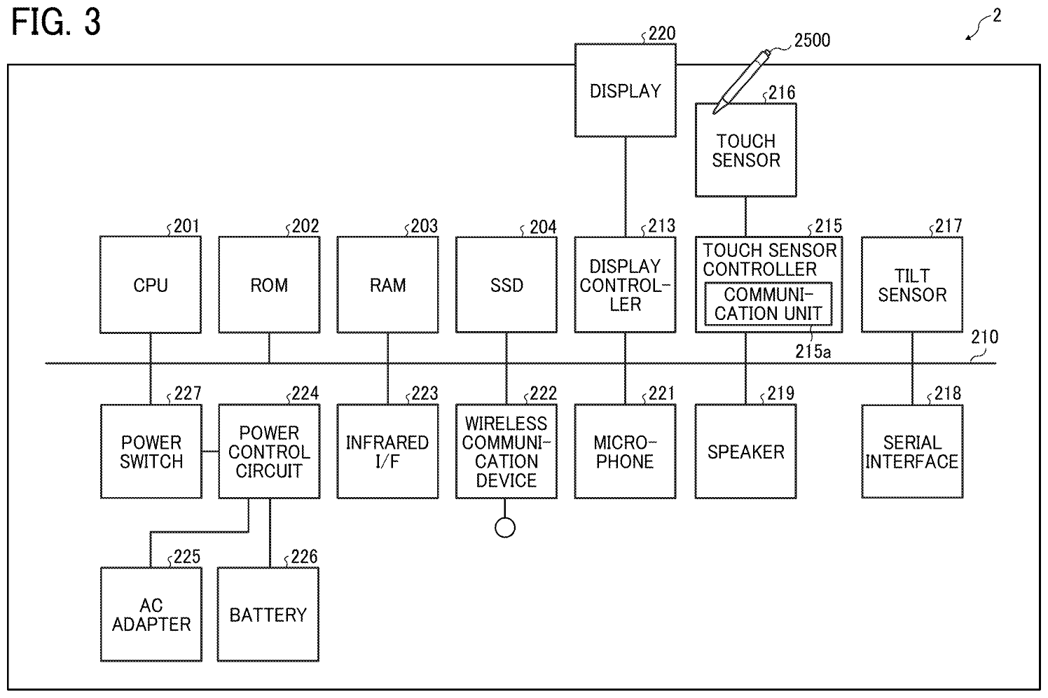

A description is given of a hardware configuration of the display apparatus 2 according to the present embodiment, with reference to FIG. 3. The display apparatus 2 has a configuration of an information processing apparatus or a computer as illustrated in the drawing. FIG. 3 is a block diagram illustrating an example of the hardware configuration of the display apparatus 2. As illustrated in FIG. 3, the display apparatus 2 includes a central processing unit (CPU) 201, a read only memory (ROM) 202, a random access memory (RAM) 203, and a solid state drive (SSD) 204.

The CPU 201 controls entire operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a control program for the display apparatus 2. This program may be an application program that runs on an information processing apparatus equipped with a general-purpose operating system (OS) such as WINDOWS, MAC OS, ANDROID, and IOS. In this case, the display apparatus 2 is usually used as a general-purpose information processing device. However, when a user executes an installed application program, the display apparatus 2 receives handwriting or the like performed by the user similarly to a dedicated display apparatus.

The display apparatus 2 further includes a display controller 213, a touch sensor controller 215, a touch sensor 216, a tilt sensor 217, a serial interface 218, a speaker 219, a display 220, a microphone 221, a wireless communication device 222, an infrared interface (I/F) 223, a power control circuit 224, an alternating current (AC) adapter 225, a battery 226, and a power switch 227.

The display controller 213 controls, for example, the display 220 to output an image thereon. The touch sensor 216 detects that the pen 2500, a user's hand or the like is brought into contact with the display 220. The pen or the user's hand is an example of input device. The touch sensor 216 also receives a pen identifier (ID).

The touch sensor controller 215 controls processing of the touch sensor 216. The touch sensor 216 receives touch input and detects coordinates of the touch input. A method of receiving a touch input and detecting the coordinates of the touch input will be described. For example, in a case of optical sensing, two light receiving and emitting devices disposed on both upper side ends of the display 220 emit infrared ray (a plurality of lines of light) in parallel to a surface of the display 220. The infrared ray is reflected by a reflector provided around the display 220, and two light-receiving elements receive light returning along the same optical path as that of the emitted light.

The touch sensor 216 outputs position information of the infrared ray that is blocked by an object after being emitted from the two light receiving and emitting devices, to the touch sensor controller 215. Based on the position information of the infrared ray, the touch sensor controller 215 detects a specific coordinate that is touched by the object. The touch sensor controller 215 further includes a communication circuit 215a for wireless communication with the pen 2500. For example, when communication is performed in compliance with a standard such as BLUETOOTH (registered trademark), a commercially available pen can be used. When one or more pens 2500 are registered in the communication circuit 215a in advance, the display apparatus 2 communicates with the pen 2500 without connection setting between the pen 2500 and the display apparatus 2, performed by the user.

The power switch 227 turns on or off the power of the display apparatus 2. The tilt sensor 217 detects the tilt angle of the display apparatus 2. The tilt sensor 217 is mainly used to detect whether the display apparatus 2 is being used in any of the states in FIG. 2A, 2B, or 2C. For example, the display apparatus 2 automatically changes the thickness of characters or the like depending on the detected state.

The serial interface 218 is a communication interface to connect the display apparatus 2 to extraneous sources such as a universal serial bus (USB). The serial interface 218 is used to input information from extraneous sources. The speaker 219 is used to output sound, and the microphone 221 is used to input sound. The wireless communication device 222 communicates with a communication terminal carried by the user and relays the connection to the Internet, for example.

The wireless communication device 222 performs communication in compliance with Wi-Fi, BLUETOOTH (registered trademark) or the like. Any suitable standard can be applied other than the Wi-Fi and BLUETOOTH (registered trademark). The wireless communication device 222 forms an access point. When a user sets a service set identifier (SSID) and a password that the user obtains in advance in the terminal carried by the user, the terminal is connected to the access point.

It is preferable that two access points are provided for the wireless communication device 222 as follows:

(a) Access point to the Internet; and (b) Access point to Intra-company network to the Internet. The access point (a) is for users other than, for example, company staffs. The access point (a) does not allow access from such users to the intra-company network but allow access to the Internet. The access point (b) is for intra-company users and allows such users to access the intra-company network and the Internet.

The infrared I/F 223 detects an adjacent display apparatus 2. The infrared I/F 223 detects an adjacent display apparatus 2 using the straightness of infrared rays. Preferably, one infrared I/F 223 is provided on each side of the display apparatus 2. This configuration allows the display apparatus 2 to detect the direction in which the adjacent display apparatus 2 is disposed. Such arrangement extends the screen. Accordingly, the user can instruct the adjacent display apparatus 2 to display a previous handwritten object. That is, one display 220 (screen) corresponds to one page, and the adjacent display 220 displays the handwritten object on a separate page.

The power control circuit 224 controls the AC adapter 225 and the battery 226, which are power supplies for the display apparatus 2. The AC adapter 225 converts alternating current shared by a commercial power supply into direct current.

In a case where the display 220 is a so-called electronic paper, the display 220 consumes little or no power to maintain image display. In such case, the display apparatus 2 may be driven by the battery 226. With this structure, the display apparatus 2 is usable as, for example, a digital signage in places such as outdoors where power supply connection is not easy.

The display apparatus 2 further includes a bus line 210. The bus line 210 is an address bus or a data bus that electrically connects the elements illustrated in FIG. 3, such as the CPU 201, to each other.

The touch sensor 216 is not limited to an optical touch sensor, but may use, for example, a capacitive touch panel that locates a contact position by detecting a change in capacitance. The touch sensor 216 may be a resistive-film touch panel that determines the touched position based on a change in voltage across two opposing resistive films. The touch sensor 216 may be an electromagnetic inductive touch panel that detects electromagnetic induction generated by a touch of an object onto a display to determine the touched position. The touch sensor 216 can be of a type that does not require an electronic pen to detect whether the pen tip is in contact with the surface of the display 220. In this case, a fingertip or a pen-shaped stick is used for touch operation. In addition, the pen 2500 can have any suitable shape other than a slim pen shape.

Functions

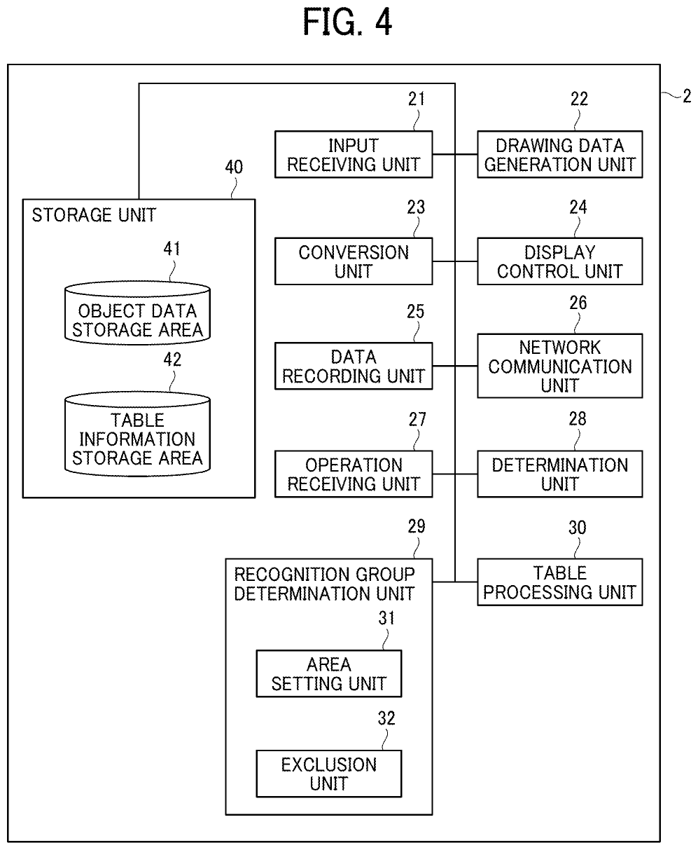

A description is now given of a functional configuration of the display apparatus 2 according to the present embodiment, with reference to FIG. 4. FIG. 4 is a block diagram illustrating an example of the functional configuration of the display apparatus 2 according to the present embodiment. The display apparatus 2 includes an input receiving unit 21, a drawing data generation unit 22, a conversion unit 23, a display control unit 24, a data recording unit 25, a network communication unit 26, an operation receiving unit 27, a determination unit 28, recognition group determination unit 29, a table processing unit 30, an area setting unit 31, and an exclusion unit 32. The functional units of the display apparatus 2 are implemented by or are caused to function by operation of one or more of the elements illustrated in FIG. 3 according to an instruction from the CPU 201 according to a program loaded from the SSD 204 to the RAM 203.

The input receiving unit 21 receives an input of trajectory of coordinates (coordinate point sequence, hand drafted input data) by detecting coordinates of a position at which an input device, such as the pen 2500, contacts the touch sensor 216. The drawing data generation unit 22 acquires the coordinates (i.e., contact coordinates) of the position touched by the pen tip of the pen 2500 from the input receiving unit 21. The drawing data generation unit 22 connects a plurality of contact coordinates into a coordinate point sequence by interpolation, to generate stroke data.

The conversion unit 23 performs character recognition processing on one or more stroke data (hand drafted data) of same recognition group, hand-drafted by the user and converts the stroke data into text (one or more character codes) as an example of converted object. The conversion unit 23 recognizes characters (of multilingual languages such as English as well as Japanese), numerals, symbols (e.g., %, $, and &) concurrently with a pen operation by the user. In addition, the conversion unit 23 performs shape recognition processing on one or more stroke data (hand drafted data) hand-drafted by the user and converts the stroke data into a shape (e.g., a line, a circle, or a triangle) as another example of converted object. Although various algorithms have been proposed for the recognition method, a detailed description is omitted on the assumption that known techniques are used in the present embodiment.

The display control unit 24 displays, on the display 220, hand drafted data, a text converted from the hand drafted data, and an operation menu to be operated by the user. The data recording unit 25 stores hand drafted data input on the display apparatus 2, converted text, a screenshot on a personal computer (PC) screen, a file, and the like in a storage unit 40 (a memory). The network communication unit 26 connects to a network such as a local area network (LAN), and transmits and receives data to and from other devices via the network.

Based on the coordinates of the position in contact with the pen 2500, the operation receiving unit 27 receives selection of a particular text from a plurality of conversion candidates generated by character recognition or receives pressing of a menu.

The determination unit 28 determines whether or not a stroke is input to the table based on the conditions 1 and 2. That is, the determination unit 28 determines whether or not to display a text candidate of character recognition as the table-input text candidate 310.

The recognition group determination unit 29 determines whether or not a plurality of strokes is included in the same recognition group. The recognition group determination unit 29 includes an area setting unit 31 and an exclusion unit 32.

The area setting unit 31 sets an additional-recognition rectangle 102 for determining whether stroke data is to be included in the same recognition group differently depending on whether a time T has elapsed after the input device is separated from the touch panel. The time T may be set by the user or manufacturer of the display apparatus 2.

When the stroke data received by the input receiving unit 21 satisfies a predetermined condition, the exclusion unit 32 excludes, from the same recognition group, even the stroke data is in the additional-recognition rectangle 102.

The table processing unit 30 performs processing related to the table in accordance with the attribute set to the table. The processing is, for example, calculation (e.g., calculation of the total) of values entered in cells by table inputting or copying of a cell.

The display apparatus 2 includes the storage unit 40 implemented by, for example, the SSD 204 or the RAM 203 illustrated in FIG. 3. The storage unit 40 includes an object data storage area 41 and a table information storage area 42. The initial attribute set in the display apparatus 2 may be also stored in the storage unit 40. Alternatively, the object data storage area 41 and the table information storage area 42 may be in a memory external to the display apparatus 2 to which the display apparatus 2 accesses using the 222 wireless communication device 222.

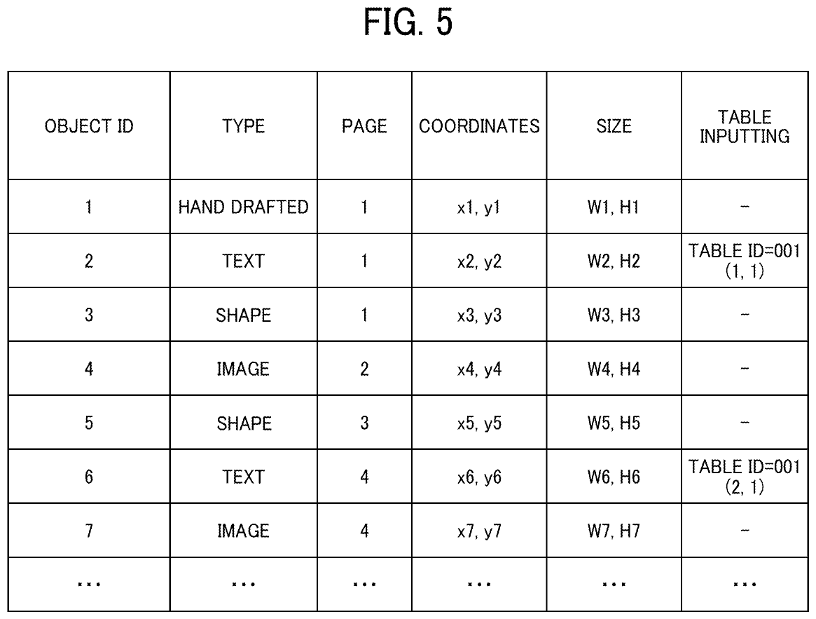

FIG. 5 is a diagram illustrating information on the object data, stored in the object data storage area 41.

The item “object ID” is identification information for identifying display data.

The item “type” is a type of object data and includes hand drafted, text, shape, image, and table, for example. “Hand drafted” indicates stroke data (coordinate point sequence). “Text” indicates a character string (one or more character codes) converted from hand drafted data. “Shape” indicates a geometric shape, such as a triangle or a tetragon, converted from hand drafted data. “Image” represents image data in a format such as Joint Photographic Experts Group (JPEG), Portable Network Shapes (PNG), or Tagged Image File Format (TIFF) acquired from, for example, a PC or the Internet. “Table” indicates a one-dimensional or two-dimensional object that is a table.

A single screen of the display apparatus 2 is referred to as a page. The item “page” represents the number of the page.

The item “coordinates” indicates a position of object data with reference to a predetermined origin on a screen of the display apparatus 2. The position of the object data is, for example, the position of the upper left apex of a circumscribed rectangle of the object data. The coordinates are expressed, for example, in pixels of the display.

The item “size” indicates a width and a height of the circumscribed rectangle of the object data.

The item “table inputting” indicates the association between the table-input object and the table. For example, a text having an object ID “2” and a text having an object ID “6” are associated with a table having a table ID “001.” In addition, the information on the object data in FIG. 5 indicates that the text having the object ID “2” and the text having the object ID “6” are respectively table-input to a cell (1, 1) and a (2, 1) of the table having the table ID “001” (associated with the table). Note that handwriting or a shape may be table-input.

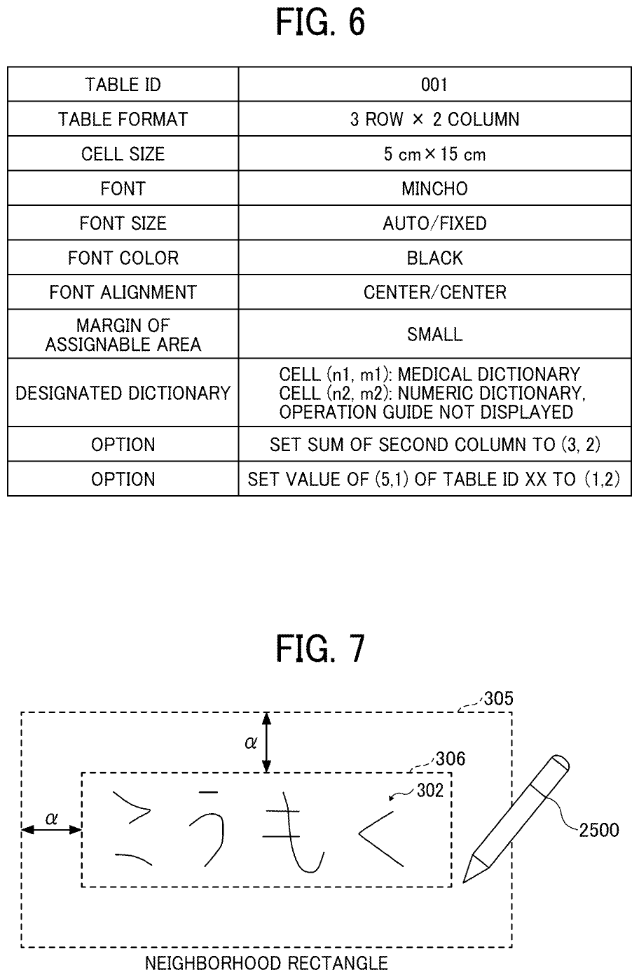

FIG. 6 is a diagram illustrating table information stored in the table information storage area 42. The table information has an attribute of a table (or each cell). In addition, the table information is information on a template serving as a base of a table, and a plurality of tables may be created based on one set of table information. The table in which values are entered in the cells is stored as object data, including the position of the table on the display.

The item “table ID” is identification information of the template of the table.

The item “table format” specifies the number of rows and the number of columns in the table.

The item “cell size” indicates the vertical and horizontal lengths of each cell included in the table. Although the cell size is uniform in FIG. 6, the cell size may be set for each row or each column.

The item “font” specifies the font of the table-input text candidate 310 that has been table-input.

The font may be settable for each cell.

The item “font size” specifies the size of the table-input text candidate 310 that has been table-input. The font size may be settable for each cell. When the font size is set to “AUTO,” the font size is automatically enlarged or reduced so that the text fits in the cell.

The item “font color” specifies the color of the table-input text candidate 310 that has been table-input. The font color may be settable for each cell.

The item “font alignment” specifies the arrangement of the table-input text candidate 310 in the cell in the horizontal direction (leftward, center, or rightward) and in the vertical direction top, center, or bottom). The font alignment may be settable for each cell.

The item “margin of assignable area” specifies the margin from the input text to the frame of the cell to be wide, medium, or narrow.

The item “designated dictionary” specifies a conversion dictionary for the entire table or per cell. In FIG. 6, a dictionary is set per cell. For example, when “pse” is handwritten in a cell in which a medical dictionary is registered, a medical term such as “pseudomembranous colitis” is displayed as the table-input text candidate 310. The display apparatus 2 can improve recognition accuracy by the dictionary registered for each cell. Further, hiding (omitting to display) the operation guide 500 may be set to a cell. The details are described later.

The item “option” is an attribute for the processing related to the table. For example, “option” is a designation related to calculation, such as entering, into a cell (3, 2), a value obtained by summing up the second column. As an option, it is also possible to designate copying a value of a cell of a certain table is copied to the cell of the table.

Determination of Whether Strokes of Same Recognition Group Overlap Table

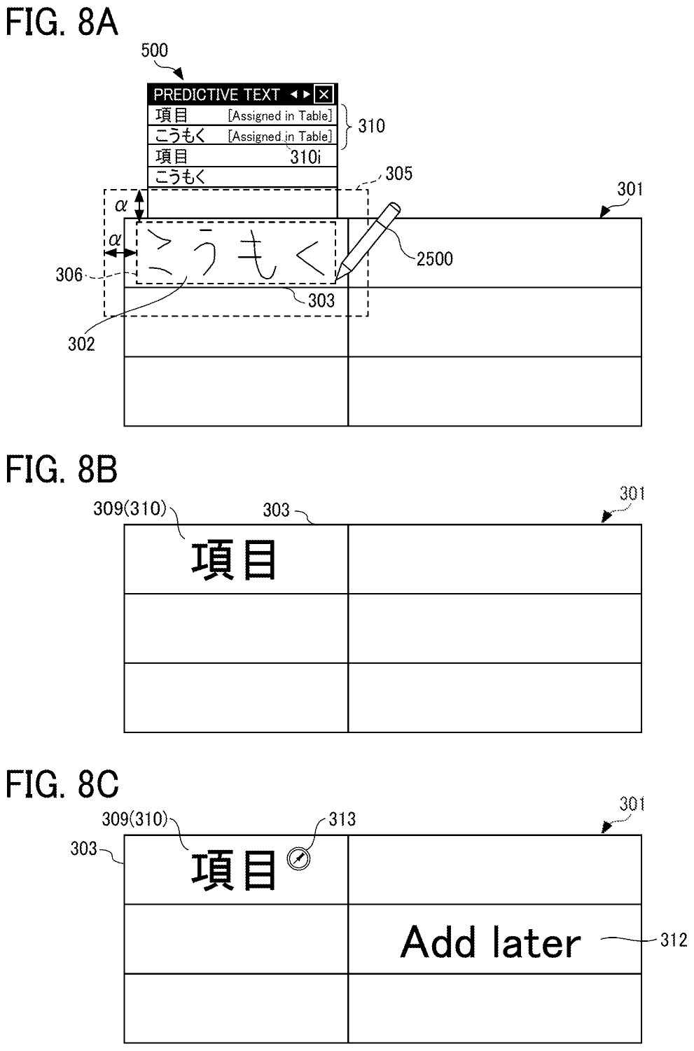

Next, with reference to FIGS. 7 to 8C, the conditions 1 and 2 used to determine whether a stroke and a table in the same recognition group overlap will be described. FIG. 7 is a diagram illustrating a neighborhood rectangle. The display apparatus 2 sets a neighborhood rectangle 305 that is a rectangle obtained by adding an offset α to each of upper, lower, left, and right sides of a circumscribed rectangle 306 of the stroke set 302 of the same recognition group.

A description is given using example values.

In a case where the offset (fixed value) α=3 cm, and the stroke set 302 of the same recognition group has a width of 15 cm and a height of 13 cm, the neighborhood rectangle 320 has the following size.

Width: offset α+width of the stroke set 302 of the same recognition group=3+15=18 [cm]

Height: offset α+height of the stroke set 302 of the same recognition group=3+13=16 [cm]

The offset (fixed value) depends on the size of the display, the number of pixels of the display, and the intended use. The above values are for an example in which hand drafted data on a 40-inch display (2880×2160 pixels) shared by several users.

FIGS. 8A to 8C are diagram illustrating an example of determination of the conditions 1 and 2.

Condition 1: a neighborhood rectangle of a stroke set of the same recognition group overlaps a table.

In FIG. 8A, the Japanese Hiragana character string “ [symbol] ” is handwritten in a cell 303 at the upper left of the table 301. The Japanese Hiragana character string “ [symbol] ” is drawn by the stroke set 302 belonging to the same recognition group, and the neighborhood rectangle 305 is set for the stroke set 302. In FIG. 8A, it is clear that the condition 1 is satisfied because the neighborhood rectangle 305 of the Japanese Hiragana character string [symbol] “ [symbol] ” overlaps the table 301 (specifically, the circumscribed rectangle of the table 301).

The circumscribed rectangle of the table 301 matches the outline of the table 301. The neighborhood rectangle 305 of the Japanese Hiragana character string “ [symbol] ” only needs to overlap a part of the table 301. The condition 1 is for the determination unit 28 to determine whether or not there is a possibility of table inputting, and the cell to which the table inputting is made is determined by the condition 2.

Next, Condition 2 is described.

Condition 2: an area ratio of an overlapping portion of a stroke set of the same recognition group with a cell relative to the stroke set is equal to or greater than a threshold.

When A represents the area of the circumscribed rectangle 306 of the stroke set 302 of the same recognition group, and B represents the overlapping area of the circumscribed rectangle 306 with a cell, the area ratio is B/A. The threshold value may be 80%, for example. Since the area ratio is 100% (the entire circumscribed rectangle 306 is within a cell 303) in FIG. 8A, the determination unit 28 determines that the condition 2 is satisfied.

Therefore, the display control unit 24 displays the table-input text candidate 310 in the conversion candidates 539. The table-input text candidate 310 is accompanied by a visual indication 310i indicating the table-input text candidate 310 (an indication that the first conversion candidate is displayed in accordance with the attribute set to the table). In FIG. 8A, the visual indication 310i indicating the table-input text candidate 310 is “Assigned in Table”, but the indication may be an icon, color, bold, or the like.

When a dictionary is registered in the cell in which the area ratio is determined to be equal to or greater than the threshold value, the conversion unit 23 converts the stroke set into the table-input text candidate 310 using the dictionary. When the user selects the table-input text candidate 310, as illustrated in FIG. 8B, the selected table-input text candidate 310 is displayed in the cell 303 in which the area ratio is determined to be equal to or greater than the threshold value. The display control unit 24 acquires the attribute of the cell 303 from the table information storage area 42 and displays the table-input text candidate 310 with the attribute set in the cell 303.

In addition, as illustrated in FIG. 8C, the user can input, for example, a text 312 “add later,” which is not the table-input text candidate 310, to the same table 301. The text 312 is not associated with the table 301. When the user moves the table 301, the table-input text candidate 310 moves together with the table 301, but the text 312 that is not the table-input text candidate 310 does not move. In the table 301 after the movement, the cell in which the text 312 other than the table-input text candidate 310 has been input becomes blank.

The same applies to the case of copying the table 301. When the user copies the table 301 and pastes a copied table at another place, only the table-input text candidate 310 can be displayed in the copied table. In the table copied from the table 301, the cell in which the text 312 other than the table-input text candidate 310 has been input becomes blank.

Accordingly, the user can input the table-input text candidate 310 to the original table 301 in advance and, based on the table 301, write the text 312 as a memo, or add the table-input text candidate 310 later. There is no need for the user to perform the switching between the handwriting recognition mode and the table inputting mode.

In addition, the display apparatus 2 may display a mark 313 around the table-input text candidate 310 so that the user can determine whether the text in the cell 303 is the table-input text candidate 310. The mark 313 may be displayed constantly or may be displayed as a mouseover event or a touch event.

Examples of Conditions 1 and 2 Applied to Shapes

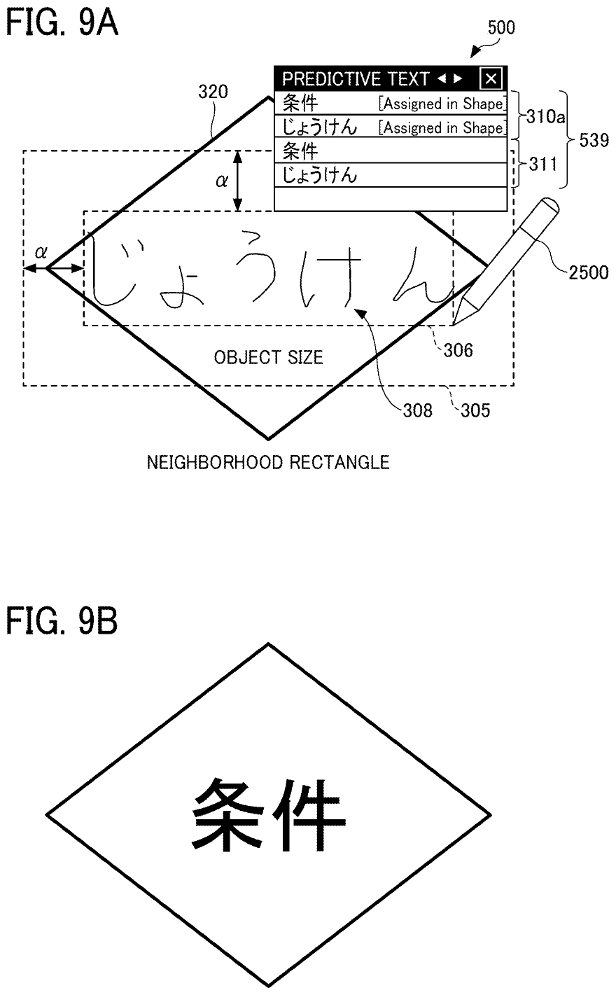

When a stroke is handwritten on a shape 320 instead of the table, whether the stroke is subjected to shape inputting is determined based on the conditions 1 and 2 similarly. The term “shape inputting” refers to formatting the stroke set in accordance with an attribute set to a shape. FIG. 9A is a diagram illustrating an example of determination of a target subjected to the shape inputting to a shape 320 based on the conditions 1 and 2. A stroke set 308 of the same recognition group represents a Japanese Hiragana character string “ [symbol] ” pronounced as “jouken” and meaning “condition.” A neighborhood rectangle 305 of the stroke set 308 overlaps a part of the shape 320. Therefore, the stroke set 308 of the same recognition group satisfies the condition 1.

Regarding the condition 2, the area ratio is D/C when C represents the area of the circumscribed rectangle 306 and D represents the overlapping area of the circumscribed rectangle 306 with the shape 320. In a case where the area ratio D/C is 90%, since the area ratio is equal to or greater than the threshold (for example, 80%), the stroke set 308 of the same recognition group satisfies the condition 2. Therefore, as illustrated in FIG. 9A, shape-input text candidates 310a are displayed in the conversion candidates 539. When the user selects, with the pen 2500, the shape-input text candidate 310a that is a Chinese character string “ [symbol] ”, the selected shape-input text candidate 310a is displayed in the shape 320 in accordance with the preset attribute of the shape 320 (FIG. 9B). The Chinese character string “ [symbol] ” is an idiom meaning “condition.”

Table Inputting

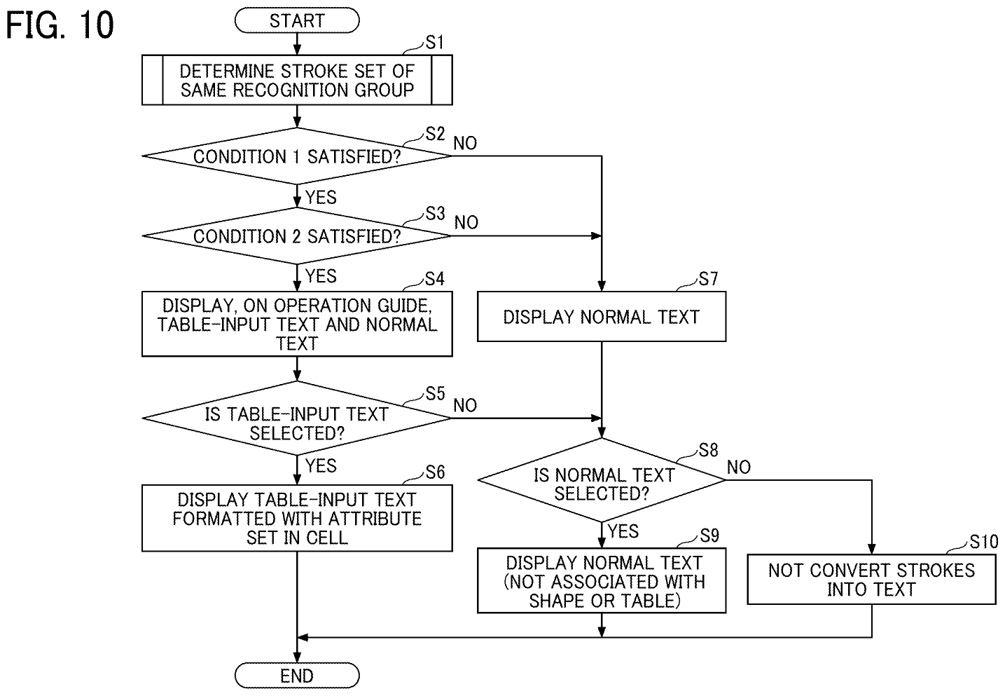

Next, with reference to FIG. 10, a description will be given of table inputting (or shape inputting) processing performed by the display apparatus 2 based on a stroke. FIG. 10 is a flowchart illustrating a process of table inputting of the table-input text candidate 310 when the stroke set of the same recognition group satisfy the conditions 1 and 2.

First, the recognition group determination unit 29 determines that a stroke set of the same recognition group is input (S1). The processing of step S1 will be described in detail later.

The determination unit 28 determines whether or not the stroke set of the same recognition group satisfies the condition 1 described above (S2). When the determination in step S2 is No, the display apparatus 2 proceeds to step S7.

When the determination in step S2 is Yes, the determination unit 28 determines whether or not the stroke set of the same recognition group satisfies the condition 2 (S3). When the determination in step S3 is No, the display apparatus 2 proceeds to step S7.

When the determination in step S3 is Yes, the display control unit 24 displays one or more table-input text candidates 310 and text other than the table-input text candidates 310 in the conversion candidates 539 (S4).

The operation receiving unit 27 determines whether or not the table-input text candidate 310 is selected (S5). When the determination in step S5 is Yes, the display control unit 24 refers to the table information storage area 42 and displays the table-input text candidate 310 in the cell in which the stroke set of the same recognition group is handwritten, with the attribute set in the cell (S6). The data recording unit 25 inputs the table ID and the coordinates (row number and column number) of the cell in the “table inputting” column of the object data.

On the other hand, in step S7, since it is determined that the stroke is not subject to the table inputting, the display control unit 24 displays the operation guide 500 including text candidates without table-input text candidates 310 (S7).

The operation receiving unit 27 determines whether a text candidate other than the table-input text candidate 310 has been selected (S8). When the determination in step S8 is Yes, the display control unit 24 displays, on the display 220 (FIG. 3) the text with the attribute initially set (S9). In this case, even if a stroke set of the same recognition group is handwritten in the table, the data recording unit 25 does not input anything in the “table inputting” column of the object data.

If the determination in step S8 is No, the conversion unit 23 does not convert the stroke set of the same recognition group to a text by character recognition (S10). The stroke set of the same recognition group is displayed as is (as handwriting).

Determination of Same Recognition Group

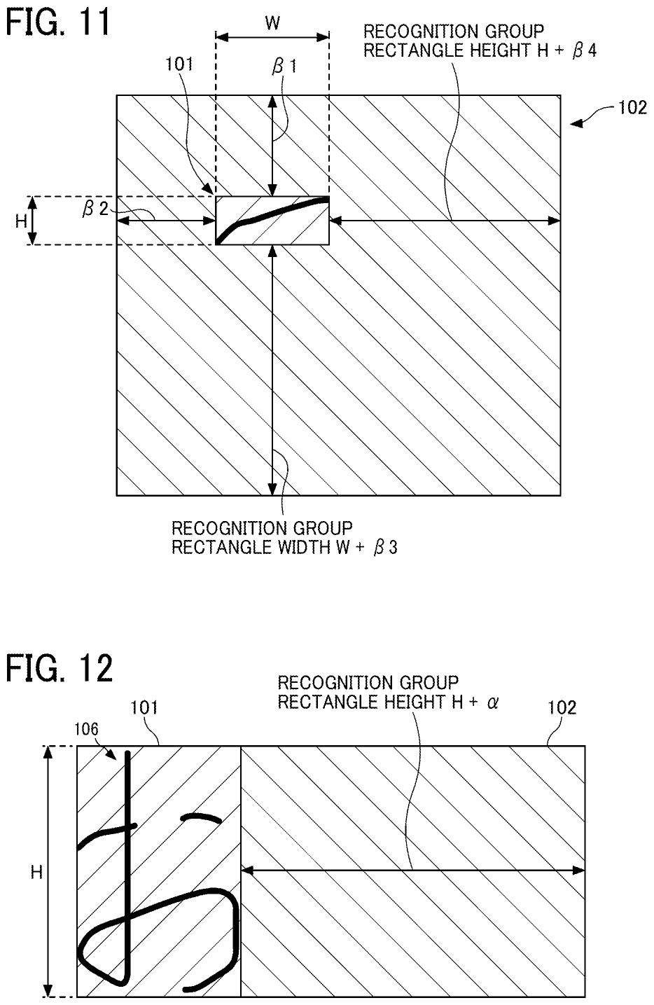

A method for determining the same recognition group is described with reference to FIG. 11 to FIG. 15.

The area setting unit 31 sets the determination area (for determining whether stroke data is to be included in the same recognition group) differently depending on whether input of stroke data is consecutively received. In other words, the determination area for determining whether to include the stroke data in the same recognition group is differently set depending on whether or not the predetermined time has elapsed after the input device is separated from the touch panel.

A description is given of a case where the time T has not elapsed from a pen-up (in successive input).

FIG. 11 is a diagram illustrating the same recognition group in a case where the time T has not elapsed from the pen-up. The circumscribed rectangle of the stroke data in consecutive input is a recognition group rectangle 101.

The area of the additional-recognition rectangle 102 is defined with respect to the recognition group rectangle 101 as follows.

The upper end of the additional-recognition rectangle 102 is offset upward by a value β1 from the upper end of the recognition group rectangle 101. The left end of the additional-recognition rectangle 102 is offset leftward by a value β2 from the left end of the recognition group rectangle 101. The lower end of the additional-recognition rectangle 102 is offset downward from the lower end of the recognition group rectangle 101 by a width W of the recognition group rectangle 101 plus a value β3. The right end of the additional-recognition rectangle 102 is offset rightward from the right end of the recognition group rectangle 101 by the height H of the recognition group rectangle 101 plus a value β4.

Stroke data having a portion protruding from the additional-recognition rectangle 102 is determined as having been handwritten in the additional-recognition rectangle 102 when the proportion of the protruding portion is equal to or less than a threshold. Stroke data handwritten in the recognition group rectangle 101 may or may not be regarded as being contained in the additional-recognition rectangle 102.

Therefore, the stroke data in the recognition group rectangle 101 and the stroke data in the additional-recognition rectangle 102 belong to the same recognition group.

The values β1 to β4 are margins. For example, β1=β2=1.5 cm, and β3=β4=2 cm. When the width W of the recognition group rectangle 101 is 1.5 cm and the height H thereof is 0.5 cm, the width and height of the additional-recognition rectangle 102 are as follows.

Width: the value β2+the width W of the recognition group rectangle 101+the height H of recognition group rectangle 101+the value β4=5.5 cm

Height: the value β1+the height H of the recognition group rectangle 101+the width W of the recognition group rectangle 101+the value β3=5.5 cm

The margins vary depending on the size of the display 220, the number of pixels, and the intended use. The above-described margins are examples in a case where hand drafted data has a size sharable by several persons on the display 220 of about 40 inches and 2880×2160 pixels. The same applies to a case where stroke is input in a manner different from consecutive input.

The values β1 and β2 are respectively added upward and leftward to the recognition group rectangle 101 as margins for receiving handwriting of stroke data in order to recognize the following stroke data. Japanese characters are often written in the downward direction or rightward direction. However, there are Japanese characters (e.g., “ [symbol] ” pronounced as “hu”) in which a stroke is drawn on the left of the previous stroke, and there are characters (e.g., “i” and “j”) in which a stroke is drawn above the previous stroke. Therefore, the additional-recognition rectangle 102 is enlarged leftward and upward directions by the value β1 and the value β2, respectively.

The margin for receiving handwriting of stroke data is provided on the right of the recognition group rectangle 101 considering the characteristics of construction of Chinese characters. For example, in a case where the user consecutively draws a stroke on the right of “ [symbol] ” (a left part of a Chinese character), the height of “ [symbol] ” is assumed to be the character size, and the additional-recognition rectangle 102 is enlarged by the size of one character in the rightward direction.

The margin is provided below the recognition group rectangle 101 considering characteristics of construction of Chinese characters. For example, in a case where the user consecutively draws a stroke below “ [symbol] ” (an upper part of a Chinese character), the width of “ [symbol] ” is assumed to be the character size, and the additional-recognition rectangle 102 is enlarged by the size of one character in the downward direction.

A description is given of a case where the time T has elapsed from a pen-up.

FIG. 12 is a diagram illustrating the same recognition group in a case where the time T has elapsed from the pen-up. The circumscribed rectangle of one or more stroke data having been input within the time T from a pen-up is the recognition group rectangle 101. The area of the additional-recognition rectangle 102 is defined with respect to the recognition group rectangle 101 as follows.

Height: height H of the recognition group rectangle 101

Width: height H of the recognition group rectangle 101+α from the right end of the recognition group rectangle 101

When the time T has elapsed from the pen-up, on the assumption of the character size of Japanese horizontal writing, the additional-recognition rectangle 102 extending in the rightward direction by one character size is provided. Specifically, the area setting unit 31 expands the additional-recognition rectangle 102 in the rightward direction by the value a on the assumption that the user handwrites a stroke rightward with a blank space from the recognition group rectangle 101.

The area setting unit 31 determines only the rightward area of the circumscribed rectangle of one or more already-input stroke data as the determination area (the additional-recognition rectangle 102) for determining whether to include the next stroke data in the same recognition group.

The display apparatus 2 groups the stroke data drawing a Japanese character 106 “ [symbol] ” (pronounced as “o”) in the recognition group rectangle 101 with the stroke data in the additional-recognition rectangle 102.

The value α is, for example, 3 cm. When the recognition group rectangle 101 has a width of 4 cm and a height of 6 cm, the additional-recognition rectangle 102 has the following width and height.

Width: height H of the recognition group rectangle 101+the value α=9 cm

Height: Height H of the recognition group rectangle 101=6 cm

As described above, the area setting unit 31 changes whether to include subsequent stroke data in the same recognition group depending on whether or not the time T has elapsed after the input device is separated from the touch panel.

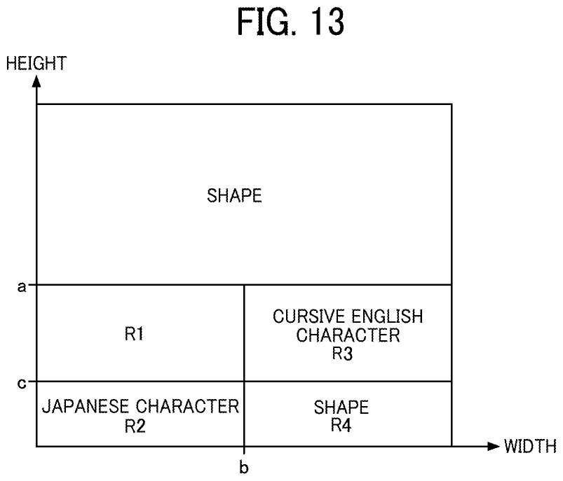

Next, a description is given of a case where stroke data is excluded from the same recognition group, with reference to FIG. 13. FIG. 13 is a diagram illustrating a condition under which stroke data is determined not to be included in the same recognition group. The exclusion unit 32 excludes, from the same recognition group, stroke data that is contained in the additional-recognition rectangle 102 but is an exception satisfying an excluding condition (i) or (ii) presented below.
(i) the stroke data has a height larger than a threshold value a; and (ii) the stroke data has a width larger than a threshold value b and a height smaller than a threshold value c smaller than the threshold value a.

The threshold values a and b are, for example, 9 cm. The threshold value c is, for example, 2.5 cm. These threshold values vary depending on, for example, the size of the display 220, the number of pixels of the display 220, and how many people share the text.

The excluding condition (i) is for setting the threshold value a as the maximum height of a character and determining that stroke data exceeding the threshold value a is a shape. The excluding condition (ii) is for determining that stroke data having a width exceeding the threshold value b is a shape. The threshold value b is the maximum width of a general character. Further, the excluding condition (ii) is for including English cursive in the same recognition group.

A description is given of determining whether stroke data belongs to the same recognition group using regions R1 to R4 divided by threshold values a, b, and c in FIG. 13.

Stroke data entirely contained in the regions R1 and R2 does not satisfy the excluding conditions (i) and (ii) and is assumed to be a Japanese character. Accordingly, the stroke data entirely contained in the regions R1 and R2 is not excluded from the same recognition group. The display apparatus 2 may recognize stroke data entirely contained in the regions R1 and R2 as English cursive.

The stroke data entirely contained in the regions R1, R2, and R3 does not satisfy the excluding conditions (i) and (ii) and is not excluded from the same recognition group. These conditions cope with English cursive. Specifically, stroke data of cursive characters such as “English” handwritten in one stroke is not excluded from the same recognition group (is not regarded as a shape), and thus the display apparatus 2 recognizes the stroke data as characters.

Stroke data entirely contained in the regions R2 and R4 satisfies the excluding condition (ii) and is assumed to be a shape (for example, a horizontal line). Accordingly, the stroke data entirely contained in the regions R2 and R4 is excluded from the same recognition group.

Accordingly, the stroke data entirely contained in the regions R1 to R4 does not satisfy the excluding conditions (i) and (ii) and is not excluded from the same recognition group. Also in this case, English cursive can be recognized.

As described above, depending on whether or not the stroke data satisfies the excluding condition (i) or (ii), the exclusion unit 32 forcibly determines the stroke data contained in the additional-recognition rectangle 102 as not belonging to the same recognition group. Thus, even when a shape and a character are handwritten in a mixed manner, the conversion unit 23 separates the character from the shape, to recognize the character.

In addition to exceptions determined by the conditions (i) and (ii), stroke data of, for example, following exceptions are not included in the same recognition group.

Exception 1: The stroke data is not contained in the neighborhood rectangle.

Exception 2: An immediately preceding operation with the pen 2500 in use includes processing, such as “character conversion,” other than stroke drawing. Exception 3: In a special example such as area control, stroke data is determined as being input in another area. Exception 4: The pen type is different.

Processing or Operation relating to Determination of Same Recognition Group

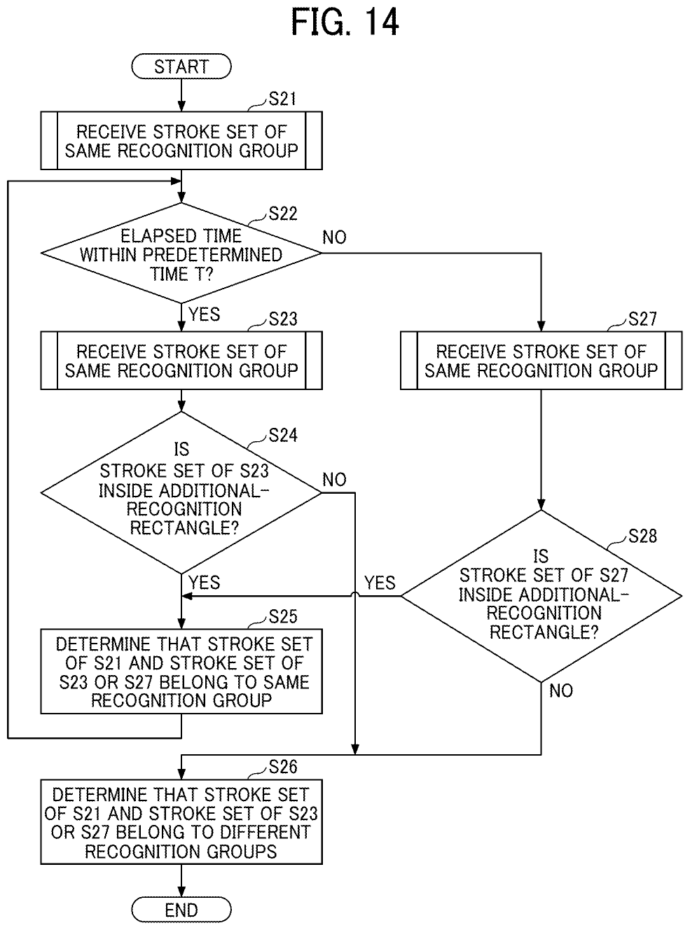

FIG. 14 is a flowchart illustrating a process in which the recognition group determination unit 29 determines stroke data of the same recognition group. The process of FIG. 14 is repeatedly executed while the display apparatus 2 is on.

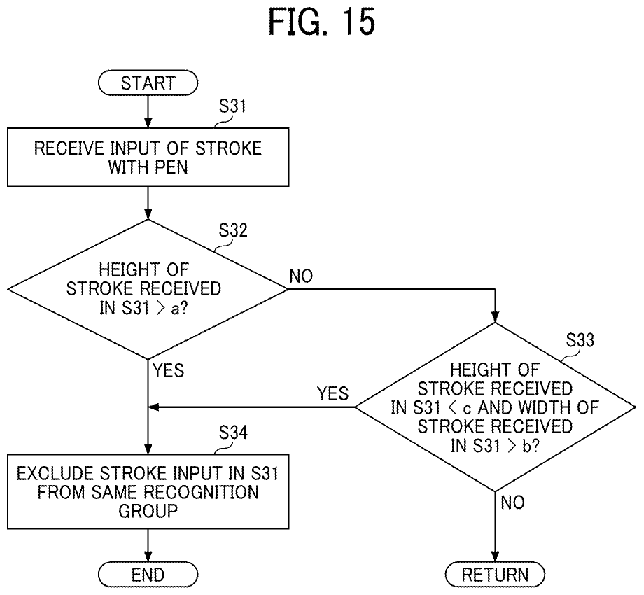

The input receiving unit 21 detects coordinates of the points touched by the input device, and the drawing data generation unit 22 generates stroke data. The display control unit 24 controls the display 220 to display the stroke data. The exclusion unit 32 determines whether or not the stroke data satisfies the excluding condition for excluding the stroke data from the same recognition group. Stroke data that disagrees with the excluding conditions (i.e., stroke data determined as belonging to the same recognition group) is subjected to subsequent processing (S21). The determination of step S21 will be described with reference to the flowchart of FIG. 15.

The area setting unit 31 determines whether or not the time T has elapsed from a pen-up after completion of input of the stroke set in step S21 (S22).

In a state where the time T has not elapsed (Yes in S22), the input receiving unit 21 detects the coordinates of the points touched by the input device, and the drawing data generation unit 22 generates stroke data. The display control unit 24 controls the display 220 to display the stroke data. The exclusion unit 32 determines whether or not the stroke data of S22 satisfies the excluding condition for excluding the stroke data from the same recognition group. When the stroke data does not satisfy the excluding condition, the stroke data that belongs to the same recognition group is received (S23). Only stroke data that disagrees with the excluding conditions for excluding the stroke data from the same recognition group (i.e., stroke data determined as belonging to the same recognition group) is subjected to subsequent processing.

The area setting unit 31 sets the additional-recognition rectangle 102 in consecutive input based on the stroke data of step S21 and determines whether the stroke data of step S23 is contained in the additional-recognition rectangle 102 (S24).

When the stroke data of step S23 is determined as being contained in the additional-recognition rectangle 102 (Yes in S24), the area setting unit 31 determines that the stroke data of step S21 and the stroke data of S23 belong to the same recognition group (S25).

When the stroke data of step S23 is not contained in the additional-recognition rectangle 102 (No in S24), the area setting unit 31 determines that the stroke data of step S21 and the stroke data of S23 belong to different recognition groups, that is, exclude the stroke data of S23 from the recognition group of stroke data of step S21 (S26).

In a state where the elapsed time from the pen-up after the handwriting of the stroke in step S21 exceeds the time T (No in S22), the input receiving unit 21 detects coordinates of the points touched by the input device, and the drawing data generation unit 22 generates stroke data. The display control unit 24 controls the display 220 to display the stroke data. The exclusion unit 32 determines whether or not the stroke data satisfies the excluding condition for excluding the stroke data from the same recognition group. When the stroke data does not satisfy the excluding condition, the stroke data that belongs to the same recognition group is received. Stroke data that disagrees with the excluding condition for excluding the stroke data from the same recognition group is subjected to subsequent processing (S27).

Next, the area setting unit 31 sets the additional-recognition rectangle 102 for the case where the time T has elapsed, based on the stroke data of step S21, and determines whether or not the stroke data of step S27 is contained in the additional-recognition rectangle 102 (S28).

When the stroke data of step S27 is determined as being contained in the additional-recognition rectangle 102 (Yes in S28), the area setting unit 31 determines that the stroke data of step S21 and the stroke data of S27 belong to the same recognition group (S25).

When the stroke data of step S27 is not contained in the additional-recognition rectangle 102 (No in S28), the area setting unit 31 determines that the stroke data of step S21 and the stroke data of S27 belong to different recognition groups (S26).

FIG. 15 is a flowchart for determining whether the stroke data satisfies the excluding condition for exclusion from the same recognition group, described in steps S21, S23, and S27 in FIG. 14.

The input receiving unit 21 detects coordinates of the points touched by the input device, and the drawing data generation unit 22 generates stroke data. The display control unit 24 controls the display 220 to display the stroke data (S31).

The exclusion unit 32 determines whether or not the height of the stroke data is larger than the threshold value a (S32).

When the height of the stroke data is equal to or smaller than the threshold value a (No in S32), the exclusion unit 32 determines whether the width of the stroke data in step S31 is larger than the threshold value b and the height thereof is smaller than the threshold value c (S33).

In a case where the determination of either step S32 or step S33 is Yes, the exclusion unit 32 excludes the stroke data of step S31 from the same recognition group (S34).

When the determination in step S33 is No, the area setting unit 31 determines that the stroke data of step S31 is to be subjected to the determination of the same recognition group. That is, the area setting unit 31 determines whether or not the stroke data of step S31 is contained in the additional-recognition rectangle 102 in the process of FIG. 14.

Hiding Operation Guide

Although it has been described with reference to FIG. 6 that a dictionary for conversion into text can be set in a cell of a table, for example, when a numeral dictionary is set in a cell, it is assumed that only numerals are input to the cell. It is known that the recognition accuracy of numerals is higher than that of characters. In such a case, hiding of (omitting to display) the operation guide 500 (FIG. 9A) may be set as the attribute of the cell. When a stroke is handwritten in a cell in which hiding of the operation guide 500 is set, the display control unit 24 does not display the operation guide 500 (the conversion candidates 539 including the table-input text candidate 310). Instead, the display control unit 24 displays, in the cell, a text having the highest accuracy determined by the conversion unit 23 based on the designated dictionary. In a cell in which a numeral is to be entered, this configuration can, for example, reduce erroneous conversion and obviates the user's selecting the table-input text candidate 310 from the conversion candidates 539.

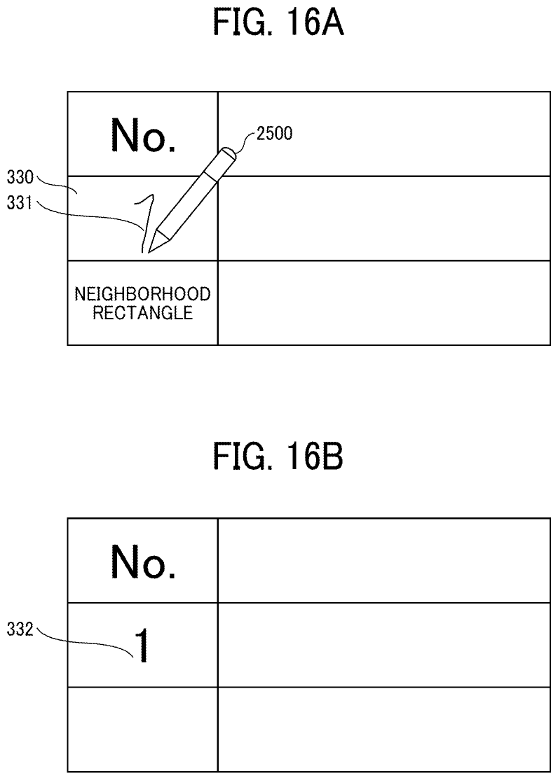

FIGS. 16A and 16B illustrate a conversion example of a stroke 331 handwritten in a cell in which the hiding of the operation guide 500 is set. In FIG. 16A, a stroke 331 representing “1” is handwritten in a cell 330. In the cell 330, a numeral dictionary is designated, and the hiding of the operation guide 500 is set. Therefore, as illustrated in FIG. 16B, the operation guide 500 is not displayed, and a text 332 “1” determined as having the highest accuracy is displayed in the cell 330.

Table Inputting of Table-Input Text Candidate

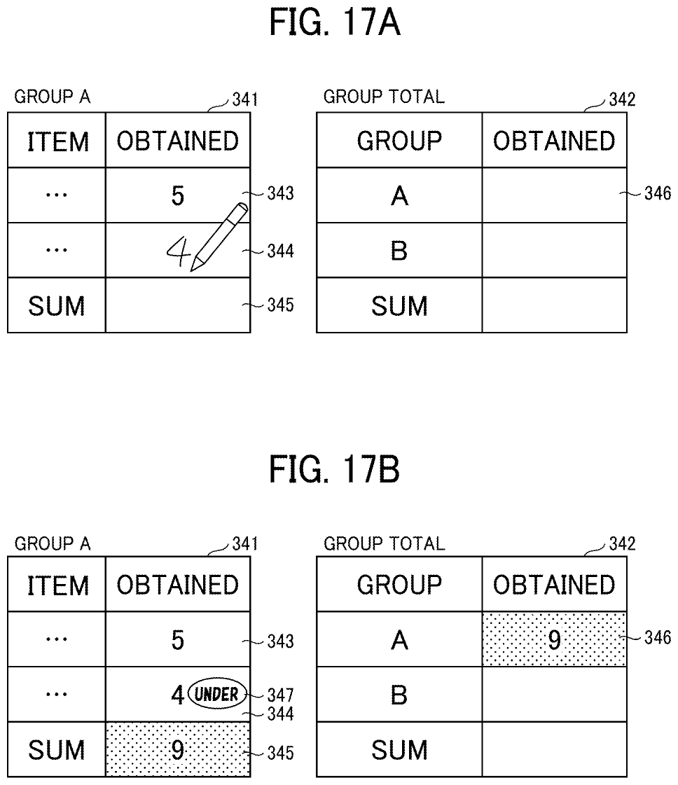

Referring to FIGS. 17A and 17B, a description will be given of a process performed on the table-input text candidate 310 by the table processing unit 30. FIGS. 17A and 17B are diagrams illustrating automatic calculation of a sum and copying of a value of a cell. FIG. 17A illustrates different tables 341 and 342. The summary of the table 341 is entered in the table 342.

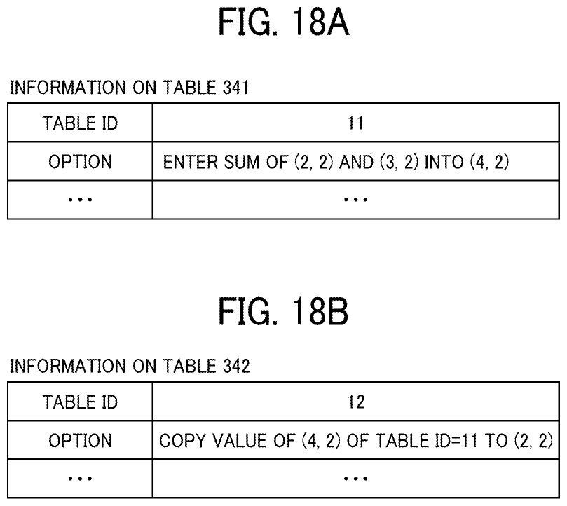

FIGS. 18A and 18B illustrate table information of the tables 341 and 342. In FIGS. 18A and 18B, only the optional items related to the processing of the tables 341 and 342 are presented. As illustrated in FIG. 18A, the table 341 has a table ID “11,” and entering the sum of cells (2, 2) and (3, 2) into a cell (4, 2) is registered as an option. As illustrated in FIG. 18B, the table 341 has a table ID “12,” and copying the value of the cell (4, 2) associated with the table ID “11” to a cell (2, 2) is registered as an option. The table processing unit 30 refers to the table information illustrated in FIGS. 18A and 18B and performs the following processing.

According to the table information, a cell 345 of the table 341 in FIG. 17A is assigned with an attribute indicating the sum of the values of cells 343 and 344 in the same column. As illustrated in FIG. 17A, when “5” and “4” are input to the cells 343 and 344 of the table 341, the table processing unit 30 determines the presence or absence of an option at the timing of table inputting of a value to each of the cells 343 and 344. Both the values “5” and “4” are table-input and are associated with the table 341.

When the table processing unit 30 determines the presence of the cell 345 assigned with the option and the values are input to the cells 343 and 344 subjected to the processing of the cell 345, the table processing unit 30 performs processing of the cell 345 assigned with the option. For example, as illustrated in FIG. 17B, the table processing unit 30 enters a value “9,” which is the total of the cells 343 and 344 in the same column, in the cell 345 of the table 341.

Further, based on the table information of FIG. 18B, the table processing unit 30 determines that the table 342 is set with the option of using the value of the other table 341. In this case, the table processing unit 30 checks the input state of the other table 341 at regular time intervals, for example. When the value (sum of (4, 2)) used for the option of the table 342 is input in the other table 341, the table processing unit 30 uses the value of the table 341 to execute the processing of the option of the table 342.

As illustrated in FIG. 17B, the table processing unit 30 copies the value of the cell 345 (4, 2) of the table 341 to a cell 346 (2, 2) of the table 342.

In this way, the display apparatus 2 can automatically process the values entered in the table in accordance with the attributes set in the table.

Note that the display apparatus 2 can receives hand drafted data and text that are not subjected to the table inputting in the table without switching the mode. In the table 341 of FIG. 17B, a handwritten text 347 is input to a cell 344. The handwritten text 347 is not associated with the table 341 and does not affect the total value displayed in the cell 345. Therefore, the display apparatus 2 of the present embodiment allow mixture of the table-input text candidate 310 and other text or hand drafted data in one table and can display or process only the table-input text candidate 310 in accordance with the attribute. As described above, the present embodiment has an advantage over conventional spreadsheet software that does not calculate the sum of numerals of cells in a case where a numeral and a character string are input in one of the cells.

Application to Client-Server System

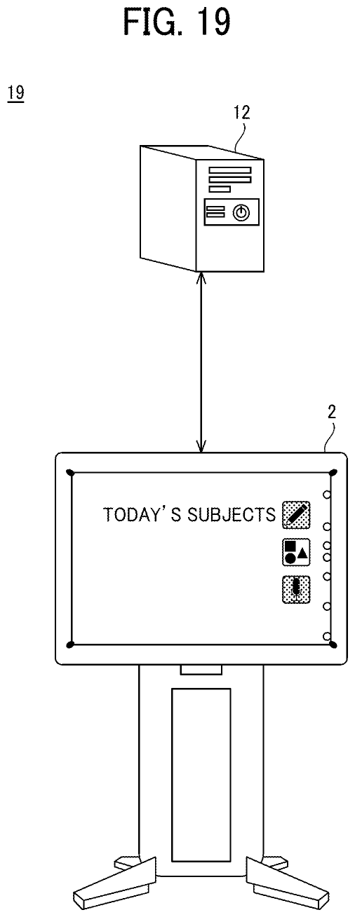

FIG. 19 is a schematic diagram illustrating an example of a configuration of a display system 19 according to the present embodiment. The function of the display apparatus 2 can also be implemented in a client-server system as illustrated in FIG. 19. The display apparatus 2 and a server 12 are connected to each other through a network such as the Internet.

In the display system 19, the display apparatus 2 includes the input receiving unit 21, the drawing data generation unit 22, the display control unit 24, the network communication unit 26, and the operation receiving unit 27 illustrated in FIG. 4.

By contrast, the server 12 includes the conversion unit 23, the data recording unit 25, the determination unit 28, the recognition group determination unit 29, the table processing unit 30, the area setting unit 31, the exclusion unit 32, and the network communication unit 26.

The network communication unit 26 of the display apparatus 2 transmits the stroke data to the server 12. The server 12 performs the processing similar to those illustrated in the flowcharts of FIGS. 10, 14, and 15 and transmits the recognition result to the display apparatus 2. In one example, the table information storage area 42 is in a memory of the server 12, and the server 12 transmits the table information (attributes) to the display apparatus 2. The object data storage area 41 may also be in the memory of the server 12.

As described above, in the display system 19, the display apparatus 2 and the server 12 interactively process and display text data. In addition, since the object data is stored in the server 12, the display apparatus 2 or a PC disposed at a remote site can connect to the server 12 and share the object data in real time.

As described above, the display apparatus 2 according to the present embodiment obviates the user operation of switching the mode, for performing character recognition without table inputting and performing table inputting of a character-recognized text. Table-input texts can be displayed and processed according to table attributes, and texts that are not targets of table inputting are not affected by the table attributes. In addition, the display apparatus 2 of the present embodiment determines whether or not a stroke set of the same recognition group overlaps a cell and displays the table-input text candidate 310 selectably by the user. Accordingly, a cell and a text can be accurately associated.

While example embodiments of the present disclosure have been described, the present disclosure is not limited to the details of the embodiments described above, and various modifications and improvements are possible within a scope not departing from the gist of the present disclosure. For example, elements and/or features of different illustrative embodiments may be combined with each other and/or substituted for each other within the scope of the present invention. Any one of the above-described operations may be performed in various other ways, for example, in an order different from the one described above.

For example, when a stroke extends over a plurality of cells, the display control unit 24 may temporarily display the table-input text candidate 310 selected from the operation guide 500 in all the cells extending over the plurality of cells and delete the table-input text candidate 310 from the cells other than the cell touched by the user with the pen 2500.

In addition, the display apparatus 2 may move the table-input text candidate 310 input to a cell to another cell according to a user operation.

In addition, the display apparatus 2 may display hand drafted data drawn by the user as a value of a cell of the table not converted into a text or a shape (for example, center alignment in the cell). That is, the hand drafted data becomes a part of the table 301, and the user can move the hand drafted data together with the table. The user can select whether the hand drafted data is to become a part of the table 301 or to be simply laid over the table 301.

In the above-described embodiments, the stroke data is converted mainly into Japanese, but the conversion target language of the stroke data may be other languages (English, Chinese, Hindi, Spanish, French, Arabic, Russian, etc.).

In the description above, the display apparatus 2 being an electronic whiteboard is described as an example but is not limited thereto. A device having a substantially the same functions as the electronic whiteboard may be referred to as an electronic information board, an interactive board, or the like. The present disclosure is applicable to any information processing apparatus having a touch panel. Examples of the information processing apparatus with a touch panel include, but not limited to, a projector, an output device such as a digital signage, a head up display, an industrial machine, an imaging device, a sound collecting device, a medical device, a network home appliance, a laptop computer (personal computer or PC), a mobile phone, a smartphone, a tablet terminal, a game console, a personal digital assistant (PDA), a digital camera, a wearable PC, and a desktop PC.

The display apparatus 2 may detect the coordinates of the tip of the pen using ultrasonic waves, although the coordinates of the tip of the pen are detected using the touch panel in the above-described embodiment. For example, the pen emits an ultrasonic wave in addition to the light, and the display apparatus 2 calculates a distance based on an arrival time of the sound wave. The display apparatus 2 determines the position of the pen based on the direction and the distance, and a projector draws (projects) the trajectory of the pen based on stroke data.

In the block diagram such as FIG. 4, functional units are divided into blocks in accordance with main functions of the display apparatus 2, in order to facilitate understanding the operation by the display apparatus 2. The way of dividing processing in units or the name of the processing unit do not limit the scope of the present invention. The processing implemented by the display apparatus 2 may be divided into a larger number of processing units depending on the content of the processing. In addition, a single processing unit can be further divided into a plurality of processing units.

Each of the functions of the described embodiments may be implemented by one or more processing circuits or circuitry. In this specification, the “processing circuit or circuitry” in the present specification includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules designed to perform the recited functions.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Embodiments of the present disclosure can provide significant improvements in computer capability and functionality. These improvements allow users to take advantage of computers that provide more efficient and robust interaction with tables that is a way to store and present information on information processing apparatuses. In addition, embodiments of the present disclosure can provide a better user experience through the use of a more efficient, powerful, and robust user interface. Such a user interface provides a better interaction between humans and machines.

In Aspect 1, a display apparatus for displaying a table on a screen includes a memory that stores an attribute set to the table; an input receiving unit to receive an input of hand drafted data; a conversion unit to convert the hand drafted data into a converted object that is a text or a shape; a determination unit to determine whether the hand drafted data overlaps, at least partly, with the table; and a display control unit. In a case where the hand drafted data is determined as overlapping the portion of the table, the display control unit displays the converted object in the table in accordance with the attribute set to the table.

According to Aspect 2, in the display apparatus of Aspect 1, in a case where the hand drafted data overlaps the table, the display control unit displays, on the screen, a first conversion candidate to be displayed in accordance with the attribute set to the table and a second conversion candidate to be displayed in accordance with an initial attribute set in the display apparatus. Each of the first conversion candidate and the second conversion candidate is a text or a shape. In a case where selecting of the first conversion candidate is received, the display control unit displays the first conversion candidate in the table in accordance with the attribute set to the table.

According to Aspect 3, in the display apparatus of Aspect 1 or 2, the attribute set to the table includes one or more of a font, a font size, and a color of a text in the table, and an arrangement of the text in the table.

According to Aspect 4, in the display apparatus according to any one of Aspects 1 to 3, the attribute set to the table includes a designation of a dictionary used in conversion of the hand drafted data overlapping with the table.

According to Aspect 5, in the display apparatus according to Aspect 2, the attribute set to the table includes a designation that the first conversion candidate and the second conversion candidate are to be hidden and the converted object converted from the hand drafted data is to be displayed in the table in accordance with the attribute set to the table.

According to Aspect 6, in the display apparatus according to Aspect 2, the table includes cells, the attribute set to the table includes a designation of calculation on a value input to a specific cell of the cells of the table, and the display apparatus further includes a table processing unit. In a case where the first conversion candidate being a first text is input to the specific cell, the table processing unit displays, in the specific cell, a result of the designated calculation on the text.

According to Aspect 7, in the display apparatus according to any one of Aspects 1 to 5, the attribute set to the table includes a designation of copying a value from another table. In a case where a value is input to the another table, the value copied from the another table is displayed in the table.

According to Aspect 8, in the display apparatus according to Aspect 6, in a case where selection of the second conversion candidate being a second text is received and the second text is input to the specific cell in which the first text is input, the table processing unit displays, in the table, a result of the designated calculation performed on only the first text in the specific cell.

According to Aspect 9, in the display apparatus according to Aspect 2, the table includes cells. In a case where selection of the first conversion candidate is received for a first cell of the cells and selection of the second conversion candidate is received for a second cell of the cells, the display control unit displays the first conversion candidate and the second conversion candidate in the first cell and the second cell of the same table, respectively.

According to Aspect 10, in the display apparatus according to Aspect 9, the display control unit displays, adjacent to the first conversion candidate, an indication that the first conversion candidate is being displayed in accordance with the attribute set to the table.

According to Aspect 11, in the display apparatus according to any one of Aspects 1 to 10, in a case where a neighborhood rectangle obtained by extending a circumscribed rectangle of the hand drafted data by a certain amount of margin overlaps with a predetermined area or more of the table, the determination unit determines that the hand drafted data overlaps, at least partly, with the table.

1. A display apparatus comprising circuitry configured to:
display a table on a screen;
receive an input of hand drafted data;
determine whether the hand drafted data overlaps the table;
convert the hand drafted data into a text or a shape; and
based on a determination that the hand drafted data overlaps the table, acquire an attribute set to the table from a memory and display the text or the shape in the table in accordance with the attribute.

2. The display apparatus according to claim 1,
wherein, based on the determination that the hand drafted data overlaps the table, the circuitry is configured to display, on the screen, a first text or shape to be displayed in accordance with the attribute set to the table and a second text or shape to be displayed in accordance with an initial attribute set in the display apparatus, and
in a case where the first text or shape is selected, the circuitry is configured to display the first text or shape in the table in accordance with the attribute set to the table.

3. The display apparatus according to claim 1,
wherein the attribute set to the table includes one or more of a font, a font size, and color of a text, and an arrangement of a text in the table.

4. The display apparatus according to claim 1, wherein the attribute set to the table includes a designation of a dictionary used in conversion of the hand drafted data overlapping the table.

5. The display apparatus according to claim 2,
wherein the attribute set to the table includes a designation of omitting to display the first text or shape and the second text or shape and displaying the text or the shape in the table in accordance with the attribute set to the table.

6. The display apparatus according to claim 2,
wherein the table includes a plurality of cells,
wherein the attribute set to the table includes a designation on calculation of a value in a specific cell of the plurality of cells, and
wherein, in a case where the first text or shape being a first text is input to the specific cell, the circuitry is configured to display a result of the designated calculation on the first text in the specific cell.

7. The display apparatus according to claim 1,
wherein the attribute set to the table includes a designation of copying a value from another table, and
in a case where a value is input to the another table, the circuitry is configured to display, in the table, the value copied from the another table.

8. The display apparatus according to claim 6,
wherein, in a case where selection of the second text or shape being a second text is received and the second text is input to the specific cell in which the first text is input, the circuitry is configured to display, in the table, a result of the designated calculation on the first text, the calculation being performed irrespective of the second text.

9. The display apparatus according to claim 2,
wherein the table includes a first cell and a second cell being different from the first cell, and
wherein, in a case where selection of the first text or shape is received for the first cell and selection of the second text or shape is received for the second cell, the circuitry is configured to display the first text or shape and the second text or shape in the first cell and the second cell, respectively.

10. The display apparatus according to claim 9,
wherein the circuitry is configured to display, adjacent to the first text or shape, an indication that the first text or shape is to be input as a value of a cell of the table and displayed in accordance with the attribute set to the table.

11. The display apparatus according to claim 1, wherein the circuitry is configured to:
extend a circumscribed rectangle of the hand drafted data by a certain amount of margin, to obtain a neighborhood rectangle of the hand drafted data; and
determine that the hand drafted data overlaps the table in a case where the neighborhood rectangle overlaps a predetermined area or more of the table.

12. A display method comprising:
displaying a table on a screen;
receiving an input of hand drafted data;
converting the hand drafted data into a text or a shape;
determining whether the hand drafted data overlaps the table;
acquiring an attribute set to the table from a memory based on a determination that the hand drafted data overlaps the table; and
displaying the text or the shape in the table in accordance with the attribute.

13. A non-transitory recording medium storing a plurality of program codes which, when executed by one or more processors, causes the processors to perform a method, the method comprising:
displaying a table on a screen;
receiving an input of hand drafted data;
converting the hand drafted data into a text or a shape;
determining whether the hand drafted data overlaps the table;
acquiring an attribute set to the table from a memory based on a determination that the hand drafted data overlaps the table; and
displaying the text or the shape in the table in accordance with the attribute.
